(19) United States
(12) Patent Application Publication
(10) Pub. No.: US 2015/0086056 A1
(43) Pub. Date: Mar. 26, 2015

(54) Speaker Device

(71) Applicant: Yamaha Corporation, Hamamatsu-shi, Shizuoka (JP)

(72) Inventor: Yutaka Ikuma, Hamamatsu-shi (JP)

(21) Appl. No.: 14/397,709

(22) PCT Filed: Sep. 18, 2013
(86) PCT No.: PCT/JP2013/075182

§ 371 Date: Oct. 29, 2014

(30) Foreign Application Priority Data
Sep. 18, 2012 (JP) 2012-203853
Sep. 11, 2013 (JP) 2013-188305

(51) Int. Cl. H04R 1/02

(52) U.S. Cl. CPC H04R 1/02
USPC 381/335

(57) ABSTRACT

A speaker device is provided with: a housing having a box body and a lid for closing the box body, a partition wall configured to separate the inside of the housing to form a plurality of spaces, a plurality of speaker units accommodated in the spaces, respectively, a wiring board configured to electrically connect the speaker units to the outside, and an elastic member provided between the partition wall and the lid, and closing the gap with the periphery of the wiring board in a state that the elastic member holds the wiring board.

### TECHNICAL FIELD

This disclosure relates to a closed type speaker device having a housing (casing) to which a speaker unit is attached.

### BACKGROUND ART

A closed type speaker device is known where a speaker unit is attached to a housing having sealability. The housing is generally called an enclosure as well. Moreover, a speaker device is known that has a plurality of speaker units taking charge of different frequency bands assigned thereto.

Such a closed type speaker device is hermetically closed so that the air inside the housing (enclosed space) does not leak to the outside, and various contrivances are made on the structure of the electric signal connection between the inside of the housing and the outside of the housing.

For example, Patent Document 1 discloses to use a printed circuit board as the structure of the electric signal connection between the inside of a box body and the outside of the box body and enable an electric signal to be transmitted between the inside and outside of the box body with the sealability of the box body being maintained irrespective of warpage of the printed circuit board by pinching the printed circuit board in part of the box body having sealability vertically to the lid closing direction thereof (the direction in which the lid is engaged with the box body).

In this case, it is described that the shapes of the cross section of the printed circuit board and an angular hole formed on the box body are made the same to thereby maintain the sealability. By doing this, even if warpage occurs on the printed circuit board, the warpage of the printed circuit board can be corrected by fixing the lid, which enables the electric connection between the inside of the box body and the outside of the box body while maintaining the sealability.

### PRIOR ART DOCUMENT

### Patent Document

Patent Document 1: JP-A-5-268689

### SUMMARY OF THE INVENTION

### Problems that the Invention is to Solve

However, when a speaker device is structured as described in Patent Document 1, if the dimension accuracy of the angular hole of the box body and the printed circuit board is low, it is difficult to secure sealability. Moreover, if vibrations of the box body are transmitted to the printed circuit board, an abnormal noise (a vibrating noise, a resonant noise, etc.) can be caused by the vibrations. Further, since the warpage of the printed circuit board is corrected by pressing it by the box body, an excessive load is applied to the printed circuit board, which is a cause of solder peeling and the like.

The present disclosure is made in view of such circumstances, and an object thereof is to provide a speaker device capable of easily securing the sealability of the housing and avoiding problems such as the occurrence of an abnormal noise (a vibrating noise, a resonant noise, etc.) and solder peeling.

### Means for Solving the Problem

To attain the above-mentioned object, according to the present disclosure, there is provided a speaker device provided with: a housing having a box body and a lid for closing the box body; a partition wall configured to separate an inside of the housing to form a plurality of spaces; a plurality of speaker units accommodated in the spaces, respectively; a wiring board configured to electrically connect the speaker units to an outside; and an elastic member provided between the partition wall and the lid, and closing a gap with a periphery of the wiring board in a state that the elastic member holds the wiring board.

### Advantage of the Invention

According to the present disclosure, by closing the gap around the wiring board by the elastic member, the sealability of the spaces where the speaker units are disposed, respectively, can be easily secured, and since the wiring board is supported by being pinched between the elastic members, problems such as the occurrence of an abnormal noise and solder peeling can be avoided.

### BRIEF DESCRIPTION OF THE DRAWINGS

FIG. 1 is an external perspective view showing a speaker device of a first embodiment of the present disclosure.

FIG. 2 is an external perspective view showing a condition of the speaker device shown in FIG. 1 where a lid is closed.

FIG. 3 is a perspective view explaining a box body.

FIG. 4 is a perspective view in which the inside surface of the lid is disposed so as to face upward.

FIG. 5 is a relevant part cross-sectional view of the speaker device taken on line A-A of FIG. 2.

FIG. 6(a) to FIG. 6(c) are external perspective views showing another embodiment of an elastic member of the present disclosure.

FIG. 7(a) to FIG. 7(c) are external perspective views showing still another embodiment of the elastic member of the present disclosure.

FIG. 8 is an external perspective view showing a speaker device of a second embodiment of the present disclosure.

FIG. 9 is an external perspective view showing a speaker device of a third embodiment of the present disclosure.

### MODE FOR CARRYING OUT THE INVENTION

Hereinafter, embodiments of the present disclosure will be described by using the drawings.

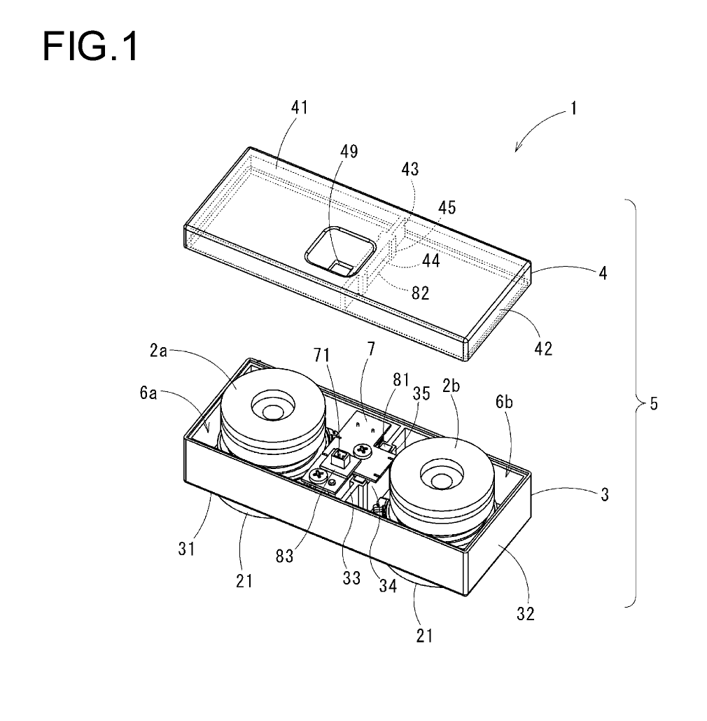

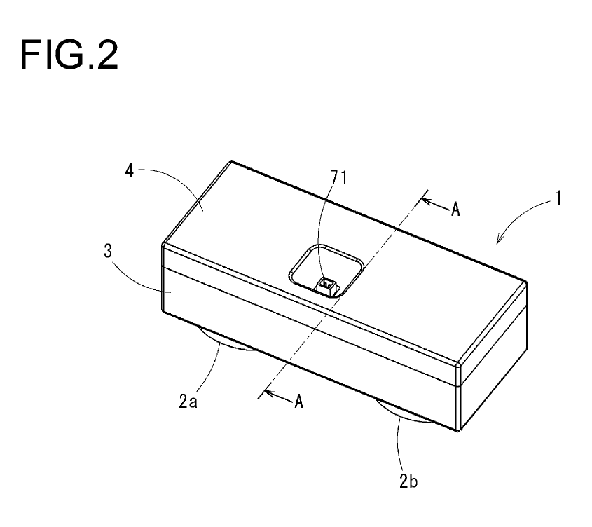

FIG. 1 and FIG. 2 are views showing a speaker device 1 of a first embodiment, a wall (bottom portion 31) having a sound emitting surface of the speaker is placed on the lower side and the back side of the speaker device 1 is placed on the upper side. The speaker device 1 is, as shown in FIG. 1, a closed type speaker device having speaker units 2a and 2b provided with a voice coil, a magnet and the like.

A housing 5 of the speaker device 1 is made of a rigid body such as plastic, and has a box body 3 to which the speaker units 2a and 2b are attached and a lid 4 closing the box body 3. In two spaces 6a and 6b formed inside the housing 5, the speaker units 2a and 2b are separately accommodated.

In FIG. 1 and FIG. 2, the speaker unit 2a taking charge of intermediate and high frequency bands is disposed in the left side space 6a of the housing 5, and the speaker unit 2b taking charge of a low frequency band is disposed in the right side space 6b.

These speaker units 2a and 2b are electrically connected to a non-illustrated external apparatus through a wiring board 7. Although not shown, the speaker units 2a and 2b and the wiring board 7 are connected by a signal line (wiring) or the like to input an electric signal for vibrating the speaker units 2a and 2b.

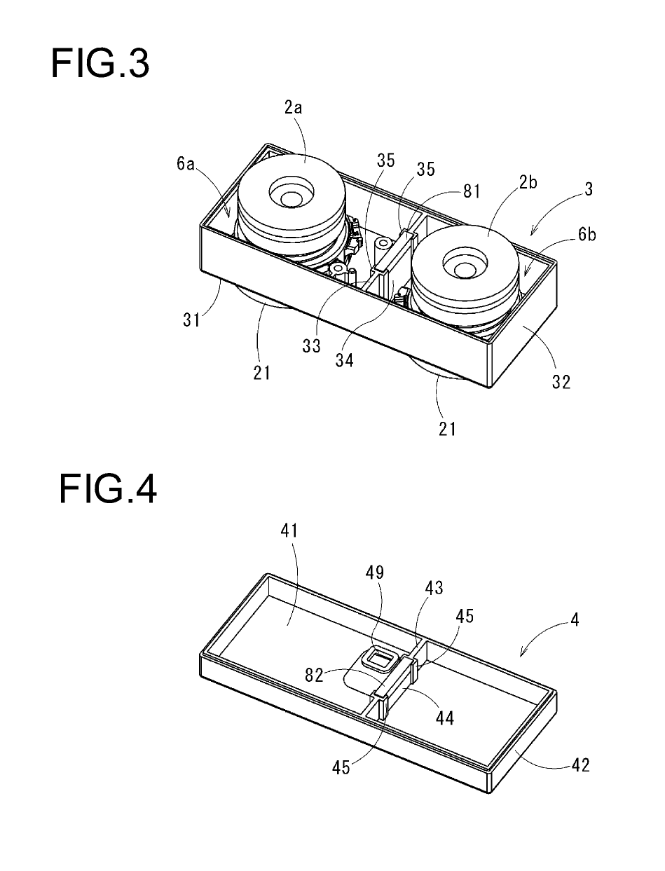

The box body 3 is provided with, as shown in FIG. 1 and FIG. 3, the bottom portion 31 bonded with cone portions 21 of the speaker units 2a and 2b being exposed to the outside, a side wall 32 vertically provided upward from the periphery of the bottom portion 31 so as to surround it, and a partition wall 33 separating into two the internal space surrounded by the side wall 32. The box body 3 is formed in a substantially rectangular parallelepiped box body shape where the back side of the speaker units 2a and 2b is opened.

Moreover, the partition wall 33 separating the spaces 6a and 6b is provided with a mount portion 34 where a lower elastic member 81 is mounted. The mount portion 34 is wider than the remaining part of the partition wall 33 when viewed from above. This mount portion 34 is provided with guide portions 35 that hold both side portions of the lower elastic member 81 so as to be removably insertable along the partition wall 33 (in a direction of attachment and detachment of the lid 4 to and from the housing 5), so that the lower elastic member 81 can be mounted on the mount portion 34 in a stable state.

In FIG. 1 and FIG. 3, the mount portion 34 is provided in a lower part between opposed parts of the guide portions 35, and the rectangular parallelepiped lower elastic member 81 is mounted on the mount portion 34.

Moreover, the lid 4 is provided with, as shown in FIG. 1 and FIG. 4, a ceiling portion 41 covering the back surfaces of the speaker units 2a and 2b, a side wall 42 vertically provided from the periphery of the ceiling portion 41 so as to surround it, and a partition wall (partition wall portion) 43 separating into two the internal space surrounded by the side wall 42. By closing the opening of the box body 3 by the lid 4, the spaces 6a and 6b partitioned by the partition walls 33 and 43 are formed inside the housing 5. Reference numeral 49 shown in FIG. 4 represents an opening formed in the ceiling portion 41 of the lid 4 in order to expose to the outside a connector 71 for external connection provided on the wiring board 7.

Moreover, on the partition wall 43 of the lid 4, a mount portion 44 and guide portions 45 are provided in a similar structure to that of the mount portion 34 of the partition wall 33 of the box body 3, and a rectangular parallelepiped upper elastic member 82 is provided on the mount portion 44. The lower elastic member 81 of the box body 3 and the upper elastic member 82 of the lid 4 are disposed so as to be opposed to each other with the wiring board 7 in between. These lower elastic member 81 and upper elastic member 82 are made of, for example, urethane resin.

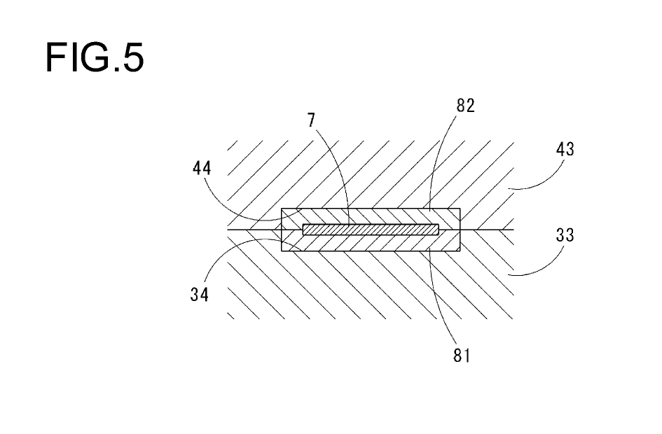

The wiring board 7 is disposed vertically to the partition walls 33 and 43 of the box body 3 and the lid 4, and as shown in FIG. 5, is disposed in a state of being pinched between the lower elastic member 81 provided on the partition wall 33 of the box body 3 and the upper elastic member 82 provided on the partition wall 43 of the lid 4. In that case, the lower elastic member 81 and the upper elastic member 82 are in contact with the wiring board 7 at the central parts thereof and are in contact with each other at both end parts thereof, thereby closing the gap around the wiring board 7.

Moreover, on the wiring board 7, the connector 71 for external connection is placed, and most part (first part) of the connector 71 is disposed, as shown in FIG. 1 and FIG. 2, on the left side of the partition walls 33 and 43, that is, in the space 6a where the speaker unit 2a taking charge of the high frequency band is disposed. On the other hand, the remaining part (second part) of the connector 71 is disposed, as shown in FIG. 1 and FIG. 2, on the right side of the partition walls 33 and 43, that is, in the space 6b where the speaker unit 2b taking charge of the low frequency band is disposed. Around the connector 71, a gasket 83 is pasted. Under a condition where the box body 3 is closed by the lid 4, although the connector 71 is exposed to the outside from the opening 49, the peripheral wall of the opening 49 formed in the ceiling portion 41 of the lid 4 is in contact with the gasket 83 provided around the connector 71, so that the sealability of the space 6a can be secured.

In the speaker device 1 structured as described above, by pinching the wiring board 7 between the lower elastic member 81 and the upper elastic member 82, the gap between the wiring board 7 and the partition walls 33 and 43 where the wiring board 7 is placed can be closed. Since a slight size difference and warpage of the wiring board 7 can be absorbed by the lower elastic member 81 and the upper elastic member 82, the sealability of the spaces 6a and 6b where the speaker units 2a and 2b are disposed, respectively, can be easily secured.

Moreover, since the wiring board 7 is in contact with the housing 5 (the partition wall 33 of the box body 3 and the partition wall 43 of the lid 4) through the lower elastic member 81 and the upper elastic member 82, vibrations of the housing 5 are not readily transmitted to the wiring board 7. Consequently, the occurrence of an abnormal noise by the vibrations can be prevented. Further, regarding the wiring board 7 held by the lower elastic member 81 and the upper elastic member 82, since the warpage of the wiring board 7 is not forcibly corrected, the occurrence of solder peeling and the like can be avoided.

Moreover, the mount portions 34 and 44 are wider than the remaining parts of the partition walls 33 and 43, and further, the guide portions 35 and 45 holding the lower elastic member 81 and the upper elastic member 82 are provided on the mount portions 34 and 44. For this reason, the lower elastic member 81 and the upper elastic member 82 can be mounted on the partition walls 33 and 34 in a stable state. And the wiring board 7 can be held in a stable state also when the wiring board 7 is mounted on the lower elastic member 81 and the upper elastic member 82 provided in this manner. Consequently, the workability of assembly can be improved, and the tolerance of the wiring board 7 to vibrations can be enhanced. Moreover, since the lower elastic member 81 and the upper elastic member 82 are removably insertable into the guide portions 35 and 45, when wear and the like occur on the lower elastic member 81 and the upper elastic member 82, the lower elastic member 81 and the upper elastic member 82 can be changed.

Moreover, in the speaker device 1, the connector 71 for external connection is provided in the space 6a where the speaker unit 2a taking charge of the high frequency band is disposed, whereas no connector for external connection is provided in the space 6b where the speaker unit 2b taking charge of the low frequency band is disposed, so that the sealability of the space 6b where the speaker unit 2b taking charge of the low frequency band is disposed can be secured with reliability.

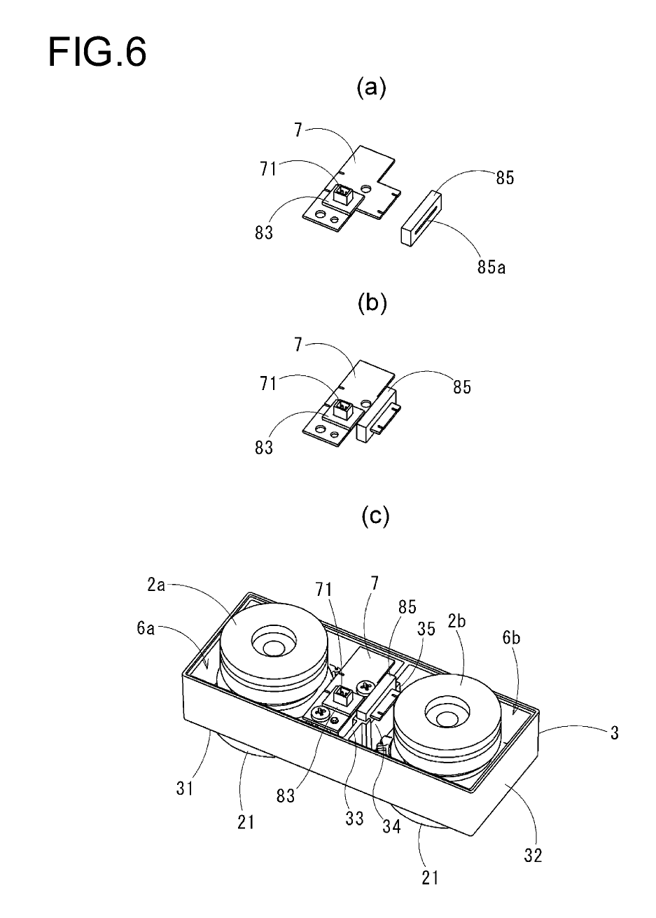

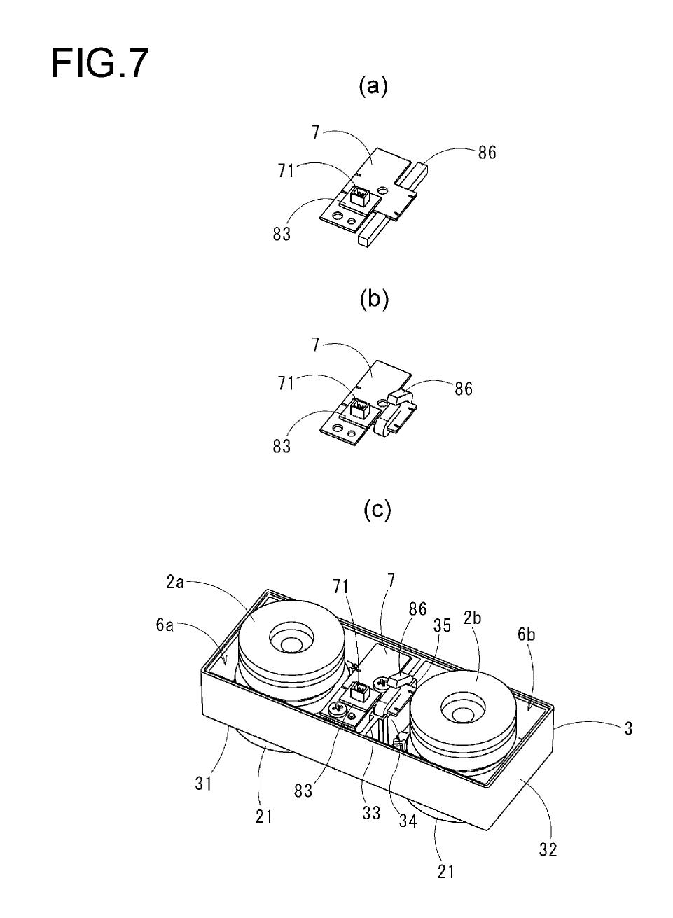

In the speaker device 1 of the above-described embodiment, the gap around the wiring board 7 is closed by the lower elastic member 81 and the upper elastic member 82 to thereby secure the sealability of the spaces 6a and 6b where the speaker units 2a and 2b are disposed, respectively. However, as substitutes for the lower elastic member 81 and the upper elastic member 82, a single elastic member 85 shown in FIG. 6(a) to FIG. 6(c) or a single elastic member 86 shown in FIG. 7(a) to FIG. 7(c) may be used.

As shown in FIG. 6(a), in the elastic member 85, a slit 85a extending in a direction parallel to the wiring board 7 is formed. As shown in FIG. 6(b), a part of the wiring board 7 is inserted or press-fitted into the slit 85a of the elastic member 85. As shown in FIG. 6(c), by assembling the wiring board 7 between the box body 3 and the lid 4 under the condition where it is inserted or press-fitted in the slit 85a of the elastic member 85 and pinched by the elastic member 85, the gap around the wiring board 7 can be easily closed. As the material for the elastic member 85, a cushion material having moderate hardness or elastomer or the like that is easy to shape with a mold is used since the slit 85a is easily formed.

Moreover, as shown in FIG. 7(a), the elastic member 86 is elongated, and the cross section thereof is, for example, square. As shown in FIGS. 7(b) and 7(c), the elastic member 86 is disposed on either the mount portion 34 or the mount portion 44, and further, the wiring board 7 is disposed on the elastic member 86. Then, by folding both end portions of the elastic member 86 so as to cover the upper surface of the wiring board 7, the end portions of the elastic member 86 are laid one over the other on the top surface of the wiring board 7 so that the wiring board 7 is pinched by the elastic member 86, whereby the gap around the wiring board 7 can also be closed. The elastic member 86 may be not only provided on the mount portion 34 on the side of the box body 3 as shown in FIG. 7(c) but also provided, although not shown, on the mount portion 44 on the side of the lid 4. The gap around the wiring board 7 may be closed by providing the elastic member 86 on either the box body 3 or the lid 4 as described above. The elastic member 86 is made of, for example, a cushion material having flexibility and restorability so that the sealability of the overlaid part of the elastic member 86 is not impaired.

FIG. 6 (c) shows a speaker device 101 of a second embodiment of the present disclosure. This speaker device 101 is, like the speaker device 1 of the first embodiment, a closed type speaker device having two speaker units 102a and 102b.

In the speaker device 101, a housing 105 has a box body 103 and a lid 104 closing the box body 103. In the housing 105, two spaces 106a and 106b separated by a partition wall 133 are formed. The speaker unit 102a taking charge of intermediate and high frequency bands and the speaker unit 102b taking charge of a low frequency band are separately accommodated in the spaces 106a and 106b of the housing 105, respectively. Moreover, a bass reflex port 109 is placed in the space 106b where the speaker unit 102b taking charge of the low frequency band is disposed, and a bass reflex type speaker system is provided. Moreover, an opening (not shown) for the bass reflex port is provided in a bottom portion 131 of the box body 103.

In FIG. 6(c), in order that the internal structure of the speaker device 101 can be checked, regarding the box body 103, a wall (bottom portion 131) having a sound emitting surface of the speaker is disposed on the lower side and the back side of the speaker device 101 is disposed so as to face upward, whereas regarding the lid 104, the inner surface side of the lid 104 is disposed so as to face upward.

The bass reflex type speaker system intensifies the low pitch sound of the speaker unit 102b by Helmholtz resonance by phase-inverting the low pitch sound generated by the speaker unit 102b by passing it through the bass reflex port 109. In order to dispose the elongated bass reflex port 109, the space 106b is formed so as to elongate toward the side opposite to the space 106a. Moreover, parts such as the connector 71 for external connection and a capacitor (not shown) mounted on a wiring board 107 are disposed on the side of the adjoining space 106a, so that the space 106b can be secured without affected by the parts such as the connector 71 and the capacitor.

The rest of the structure is the same as that of the first embodiment, and common parts are denoted by the same reference numerals and descriptions thereof are omitted.

In the speaker device 101, the sealability of the spaces 106a and 106b where the speaker units 102a and 102b are disposed, respectively, can also be secured with ease by closing the gap around the wiring board 107 by the lower elastic member 81 and the upper elastic member 82 as in the speaker device 1 of the first embodiment.

Moreover, regarding the wiring board 107, since the parts such as the connector 71 and the capacitor are unevenly distributed in the space 106a where the speaker unit 102a taking charge of the high frequency band is disposed, most of the substrate area is situated in the space 106a. For this reason, the arrangement of the wiring board 107 is unbalanced with respect to the support portion by the lower elastic member 81 and the upper elastic member 82. However, since the wiring board 107 is supported by being pinched by the lower elastic member 81 and the upper elastic member 82, the occurrence of vibrations can be suppressed, so that problems such as the occurrence of an abnormal noise and solder peeling can be avoided.

As described above, the present disclosure is also applicable to a speaker device having a bass reflex port.

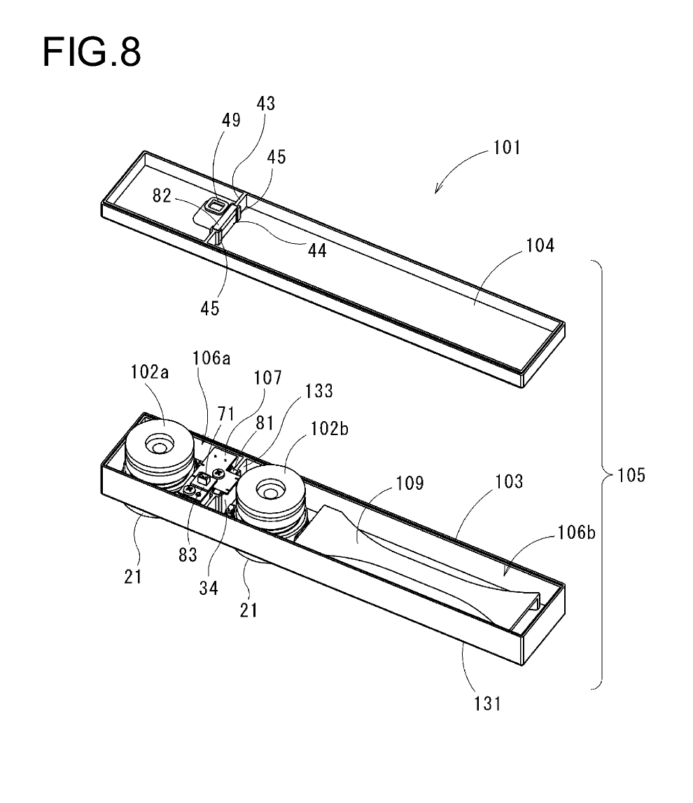

While in the second embodiment, description is given by using a speaker unit having two speaker units, a structure having three or more speaker units may be adopted such as a structure having three speaker units 202a to 202c for high pitch sounds, for intermediate pitch sounds and for low pitch sounds, respectively, like a speaker device 201 shown in FIG. 8.

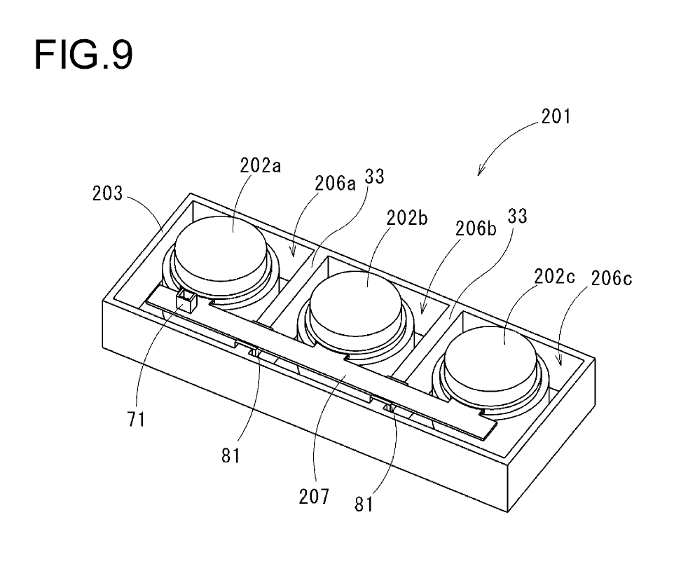

For example, in the speaker device 201 shown in FIG. 9, the speaker units 202a to 202c are accommodated in a plurality of spaces 206a to 206c lined up inside a box body 203, respectively, and these speaker units 202a to 202c are electrically connected to a wiring board 207 disposed along the longitudinal direction of the box body 203, whereby electric connection with the outside is secured through this wiring board 207. In this case, by disposing the connector 71 in the space 206a accommodating the speaker unit 202a for high pitch sounds taking charge of the highest frequency band, the sealability of the space 206c accommodating the speaker unit 202c for low pitch sounds taking charge of the low frequency band and the space 206b accommodating the speaker unit 202b for intermediate pitch sounds which spaces require high sealability is ensured, and high reliability can be maintained.

The embodiments of the present disclosure will be summarized below.

The speaker device of the present disclosure is provided with: the housing having the box body and the lid for closing the box body; the partition wall configured to separate an inside of the housing to form a plurality of spaces; a plurality of speaker units accommodated in the spaces, respectively; the wiring board configured to electrically connect the speaker units to the outside; and the elastic member provided between the partition wall and the lid, and configured to close the gap with the periphery of the wiring board in a state that the elastic member holds the wiring board.

For example, the wiring board is disposed vertically to the partition wall.

By pinching the wiring board by the elastic members, the gap between the partition wall formed for placing the wiring board and the lid can be closed. Moreover, since a certain degree of size difference and warpage (of the cross section) of the wiring board can be absorbed by the elastic members, the sealability of the spaces where the speaker units are disposed, respectively, can be easily secured.

Moreover, since the wiring board is in contact with the housing (the partition wall of the box body and the lid) through the elastic members, vibrations of the housing are not readily transmitted to the wiring board, so that the occurrence of an abnormal noise by the vibrations can be prevented. Further, since the wiring board held by the elastic members is not forcibly corrected, the occurrence of solder peeling and the like can be avoided.

For example, the partition wall has the mount portion formed so as to be wider than the remaining part of the partition wall and where the elastic member is mounted and a guide portion that holds both side portions of the elastic member, mounted on the mount portion, so as to be removably insertable along the partition wall.

By providing the mount portion wider than the remaining part of the partition wall and further providing the guide portion holding the elastic member on the mount portion, the elastic member can be mounted on the partition wall in a stable state. Moreover, since the wiring board can be held in a stable state also when the wiring board is mounted on the elastic members provided in this manner, the workability of assembly can be improved, and the tolerance of the wiring board to vibrations can be enhanced. Moreover, since the elastic members are removably insertable into the guide portions, when wear and the like occur, the elastic members can be changed.

In the speaker device of the present invention, for example, the elastic member has the lower elastic member provided on the partition wall and the upper elastic member provided on the lid, and the wiring board is disposed in a state of being pinched between the lower elastic member and the upper elastic member.

In this case, by pinching the wiring board between the lower elastic member provided on the partition wall side (box body side) and the upper elastic member provided on the lid side, the gap around the wiring board can be easily closed.

Moreover, in the speaker device of the present invention, a structure may be adopted in which the elastic member is provided on either the partition wall or the lid and the wiring board is disposed in a state of being pinched by the elastic member.

For example, the speaker units take charge of different frequency bands, respectively, the connector for external connection is provided on the wiring board, and the connector for external connection is disposed in the space accommodating the speaker unit taking charge of the high frequency band.

The space where the speaker unit taking charge of the low frequency band is disposed is higher in sound pressure level than the space where the speaker unit taking charge of the high frequency band is disposed, and is required to have a high sealability accordingly. Therefore, by providing the connector for external connection in the space where the speaker unit taking charge of the high frequency band is disposed, the sealability of the space where the speaker unit taking charge of the low frequency band is disposed can be secured with reliability.

For example, the first part of the wiring board extending in the space, of the housing, accommodating the speaker taking charge of the high frequency band is larger in mounting area than the second part of the wiring board extending in the space accommodating the speaker, of the speakers, taking charge of another frequency band.

While the present disclosure has been described in detail and with reference to specific embodiments, it is obvious to one of ordinary skill in the art that various changes and modifications are possible without departing from the spirit, scope or scope of the intension of the present disclosure.

The present invention is based upon Japanese Patent Application (Patent Application No. 2012-203853) filed on Sep. 18, 2012 and Japanese Patent Application (Patent Application No. 2013-188305) filed on Sep. 11, 2013 the contents of which are incorporated herein by reference.

### INDUSTRIAL APPLICABILITY

A speaker device capable of easily securing the sealability of the housing and avoiding problems such as the occurrence of an abnormal noise (a vibrating noise, a resonant noise, etc.) and solder peeling, particularly, a closed type speaker can be provided.

### DESCRIPTION OF REFERENCE NUMERALS AND SIGNS

1, 101, 201 Speaker device; 2a, 2b, 102a, 102b, 202a to 202c speaker unit; 3, 103, 203 box body; 4, 104 lid; 5, 105 housing; 6a, 6b, 106a, 106b, 206a to 206c space; 7, 107, 207 wiring board; 21 cone portion; 31, 131 bottom portion; 32, 42 side wall; 33, 133 partition wall; 43 partition wall (partition wall portion); 34, 44 mount portion; 35, 45 guide portion; 41 ceiling portion; 49 opening; 71 connector; 81 lower elastic member; 82 upper elastic member; 83 gasket; 109 bass reflex port

1. A speaker device comprising:
a housing having a box body and a lid for closing the box body;
a partition wall configured to separate an inside of the housing to form a plurality of spaces;
a plurality of speaker units accommodated in the spaces, respectively;
a wiring board configured to electrically connect the speaker units to an outside; and
an elastic member provided between the partition wall and the lid, and configured to close a gap with a periphery of the wiring board in a state that the elastic member holds the wiring board.

2. The speaker device according to claim 1, wherein the wiring board is disposed vertically to the partition wall.

3. The speaker device according to claim 1, wherein the partition wall includes:
a mount portion formed so as to be wider than a remaining part of the partition wall and where the elastic member is mounted; and
a guide portion configured to hold both side portions of the elastic member, mounted on the mount portion, so as to be removably insertable along the partition wall.

4. The speaker device according to claim 1, wherein the elastic member has a lower elastic member provided on the partition wall and an upper elastic member provided on the lid; and
wherein the wiring board is disposed in a state of being pinched between the lower elastic member and the upper elastic member.

5. The speaker device according to claim 1, wherein the elastic member is provided on either the partition wall or the lid; and
wherein the wiring board is disposed in a state of being pinched by the elastic member.

6. The speaker device according to claim 1, wherein the speaker units are configured to take charge of different frequency bands, respectively,
wherein a connector for external connection is provided on the wiring board; and
wherein the connector for external connection is disposed in a space accommodating the speaker unit taking charge of a high frequency band.

7. The speaker device according to claim 6, wherein a first part of the wiring board extending in the space, of the housing, accommodating the speaker taking charge of the high frequency band is larger in mounting area than a second part of the wiring board extending in a space accommodating the speaker, of the speakers, taking charge of another frequency band.
